(19) United States
(12) Patent Application Publication
(10) Pub. No.: US 2005/0270140 A1
(43) Pub. Date: Dec. 8, 2005

(54) Apparatus and a method for fingerprint authentication in a mobile communication terminal

(75) Inventor: Jong Hwan Oh, Incheon-metropolitan city (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co., Ltd

(21) Appl. No.: 11/057,592

(22) Filed: Feb. 14, 2005

(30) Foreign Application Priority Data
Jun. 4, 2004 (KR) 10-2004-0040962

(51) Int. Cl. G06K 9/00

(52) U.S. Cl. 340/5.83; 382/124

(57) ABSTRACT

Disclosed are an apparatus and a method for fingerprint authentication in a mobile communication terminal that may update a system for fingerprint authentication whenever fingerprint authentication is performed. Apparatus for fingerprint authentication in a mobile communication terminal comprising: a memory unit for configuring fingerprint data registration entries corresponding to fingerprints, the fingerprint data registration entry including a plurality of slots, and storing fingerprint data in each of the slots, the fingerprint data being captured by a fingerprint sensor provided in the mobile communication terminal; and a control unit for checking whether condition of the captured fingerprint data is adequate for fingerprint authentication, verifying whether the captured fingerprint data is fingerprint data of a same finger and performing fingerprint authentication by checking whether there is similarity between the captured fingerprint data and fingerprint data previously stored in each of the slots.

### CROSS-REFERENCE TO RELATED APPLICATION

The present application is claiming priority of Korean Patent Application No. 10-2004-0040962, filed on Jun. 4, 2004, the content of which is incorporated herein by reference.

### BACKGROUND OF THE INVENTION

1. Field of the Invention

The present invention relates to an apparatus and a method for fingerprint authentication in a mobile communication terminal. More particularly, the present invention relates to an apparatus and a method for fingerprint authentication in a mobile communication terminal that may update a system for fingerprint authentication whenever fingerprint authentication is performed.

2. Description of the Related Art

Generally, fingerprint authentication is performed as follows. A user previously stores fingerprint data in a system for fingerprint authentication. Later, when the fingerprint authentication is required, the fingerprint authentication is performed, by reading the previously stored fingerprint data and comparing with newly inputted fingerprint data.

In other words, according to a general method for fingerprint authentication in the related art, fingerprint of a genuine user is scanned, stored and registered first. Then, when fingerprint of the user is inputted by scanning, the fingerprint authentication is performed by comparing the inputted user's fingerprint data and the registered fingerprint data, and identifying the user depending on whether the inputted user's fingerprint data and the registered fingerprint data are identical with each other.

At this time, a non-optical type fingerprint sensor, generally used for the fingerprint authentication, comprises one semiconductor. Accordingly, it has a small volume and can be mass-produced, so that a manufacturing cost can be lowered.

However, the fingerprint sensor used for the fingerprint authentication is physically weak to a scratch and an external impact, and sensitive to a change of external environments such as static electricity, temperature and humidity, etc. Accordingly, there is a drawback in that there are some restrictions in obtaining identical fingerprint data all the time, since environments at the time of performing fingerprint authentication can be changed from environments when registering fingerprint data.

### BRIEF SUMMARY OF THE INVENTION

Accordingly, the present invention has been made to solve the above-mentioned problems occurring in the related art. The object of the present invention is to provide an apparatus and a method for fingerprint authentication in a mobile communication terminal that may update a system for fingerprint authentication whenever fingerprint authentication is performed.

The other object of the present invention is to cope with conditions of a fingerprint sensor or surrounding environment thereof, and to improve the probability of the fingerprint authentication, by updating a system for fingerprint registration and authentication whenever fingerprint authentication is performed.

The other object of the present invention is to adapt to a change of external environments such as static electricity, temperature and humidity, etc. by properly updating a system for fingerprint authentication corresponding to environments, instead of permanently using the registered fingerprint data, in a mobile communication terminal equipped with a fingerprint sensor.

In addition, the other object of the present invention is to improve a probability of fingerprint authentication in a mobile communication terminal equipped with a fingerprint sensor by updating a system for fingerprint authentication according to environments or a condition of a fingerprint whenever fingerprint authentication is performed.

According to the present invention, when storing and registering fingerprint data for fingerprint authentication in a mobile communication terminal equipped with a fingerprint sensor, registered fingerprint data is properly replaced with fingerprint data newly inputted when performing fingerprint authentication so as to cope with a change of environments or a condition of a fingerprint, and to improve a probability of fingerprint authentication at the same time.

In order to achieve the above objects, in whole or in parts, there is provided an apparatus for fingerprint authentication in a mobile communication terminal comprising: a memory unit for configuring fingerprint data registration entries corresponding to fingerprints, the fingerprint data registration entry including a plurality of slots, and storing fingerprint data in each of the slots, the fingerprint data being captured by a fingerprint sensor provided in the mobile communication terminal; and a control unit for checking whether condition of the captured fingerprint data is adequate for fingerprint authentication, verifying whether the captured fingerprint data is fingerprint data of a same finger, and performing fingerprint authentication by checking whether there is a similarity between the captured fingerprint data and fingerprint data previously stored in each of the slots.

Preferably, the control unit may comprise: a fingerprint registering section for recognizing a request of fingerprint registration inputted through a keypad of the mobile communication terminal; a fingerprint capture start section for generating an initialization command for initializing the fingerprint sensor after receiving the request of fingerprint registration from the fingerprint registering section, for receiving notification of fingerprint data capture completion, for requesting fingerprint data verification, and for asking a template verifying section to check whether the captured fingerprint data is similar to the fingerprint data previously stored in each of the slots; a fingerprint sensor driving section for initializing the fingerprint sensor after receiving the initialization command from the fingerprint capture start section, maintaining stand-by state until new fingerprint data is captured, and notifying the fingerprint capture start section of fingerprint data capture completion in a case where the captured fingerprint data is adequate for fingerprint authentication; an entry verifying section for receiving the request of fingerprint data verification from the fingerprint capture start section, comparing the captured fingerprint data with the fingerprint data previously stored in each of the slots, and requesting storage of the captured fingerprint data during a fingerprint data registration process in a case where there is no similarity between the captured fingerprint data and the fingerprint data previously stored in each of the slots; a template storing section for receiving the request of storing the captured fingerprint data from the entry verifying section, generating a fingerprint data registration entry corresponding to the captured fingerprint data, storing the captured fingerprint data in a template form in a first slot of the fingerprint data registration entry, and asking the fingerprint sensor driving section to prepare recapturing of fingerprint data; and the template verifying section for receiving a request of checking whether the captured fingerprint data is similar to fingerprint data stored prior to the captured fingerprint data, comparing the captured fingerprint data with the fingerprint data stored prior to the captured fingerprint data, and storing the captured fingerprint data in a template form in a slot next to a slot of the fingerprint data stored prior to the captured fingerprint data.

Preferably, the entry verifying section may compare the captured fingerprint data with the fingerprint data previously stored in the slots, and make the fingerprint capture start section generate the initialization command by notifying the fingerprint capture start section that there is a similarity between the captured fingerprint data and the fingerprint data previously stored in the slots in a case where there is fingerprint data similar to the captured fingerprint data.

Preferably, the template verifying section may comprise: a second template verifying section for comparing the captured fingerprint data with the fingerprint data stored prior to the captured fingerprint data after receiving the request of checking whether the captured fingerprint data is similar to the fingerprint data stored prior to the captured fingerprint data, storing the captured fingerprint data in a template form in a second slot of the corresponding entry in a case where there is a similarity between the captured fingerprint data and the fingerprint data stored prior to the captured fingerprint data, and requesting recapturing of fingerprint data; and a third template verifying section for comparing fingerprint data captured through the fingerprint sensor with fingerprint data stored in a first slot and a second slot after receiving the request of checking whether the captured fingerprint data is similar to the fingerprint data stored prior to the captured fingerprint data, storing the captured fingerprint data in a template form in a third slot of the corresponding entry in a case where there is similarity between the captured fingerprint data and the fingerprint data stored prior to the captured fingerprint data, and notifying the fingerprint registering section of fingerprint data registration success.

Preferably, the template verifying section may compare the captured fingerprint data with the fingerprint data stored prior to the captured fingerprint data, and make the fingerprint capture start section generate the initialization command by notifying the fingerprint capture start section that there is no similarity between the captured fingerprint data and the fingerprint data stored prior to the captured fingerprint data in a case where there is no fingerprint data similar to the captured fingerprint data.

Preferably, the control unit may comprise: a fingerprint authenticating section for recognizing a request of fingerprint authentication inputted through a keypad of the mobile communication terminal, and applying the request of fingerprint authentication and information on type of matching to a fingerprint capture start section; the fingerprint capture start section for generating an initialization command for initializing the fingerprint sensor after receiving the request of fingerprint authentication from the fingerprint authenticating section, for receiving fingerprint data capture completion, for requesting fingerprint data verification and for asking an entry verifying section to check whether the captured fingerprint data is similar to the previously stored fingerprint data; a fingerprint sensor driving section for initializing the fingerprint sensor after receiving the initialization command from the fingerprint capture start section, maintaining stand-by state until new fingerprint data is captured, and notifying the fingerprint capture start section of fingerprint data capture completion in a case where the captured fingerprint data is adequate for fingerprint authentication; and the entry verifying section for receiving the request of fingerprint data verification from the fingerprint capture start section and performing fingerprint authentication by comparing the captured fingerprint data with the fingerprint data previously stored in each of the slots.

Preferably, the entry verifying section may compare the captured fingerprint data with fingerprint data stored in a certain fingerprint data registration entry selected by a user in a case where the type of matching is 1 to 1, and compare the captured fingerprint data with fingerprint data stored in all slots in a case where the type of matching is 1 to N.

Preferably, the control unit may further comprise an updating section for forwarding to the fingerprint capture start section the notification of fingerprint authentication success and No. of fingerprint data registration entry storing fingerprint data similar to the captured fingerprint data, after receiving the notification of fingerprint authentication success from the entry verifying section, and updating the fingerprint data registration entry.

Preferably, the updating section may search fingerprint data having a least similarity among the fingerprint data in the fingerprint data registration entry, delete the fingerprint data having the least similarity from a corresponding slot of the fingerprint data registration entry, and update the fingerprint data registration entry by replacing the deleted fingerprint data with the captured fingerprint data.

In order to achieve the above objects, in whole or in parts, there is provided a method for fingerprint authentication in a mobile communication terminal comprising: registering a plurality of fingerprint data by capturing the fingerprint data through using fingerprint sensor provided in the mobile communication terminal, checking whether the fingerprint data is fingerprint data of a same fingerprint, and storing the fingerprint data in slots consisting of one fingerprint data registration entry in a case where the fingerprint data is fingerprint data of a same finger; and performing fingerprint authentication by checking whether a fingerprint data captured for fingerprint authentication is adequate for fingerprint authentication and checking whether there is a similarity between the captured fingerprint data and the fingerprint data stored in slots.

Preferably, the act of registering a plurality of fingerprint data may comprise: initializing the fingerprint sensor when receiving a request of fingerprint registration inputted from a keypad of the mobile communication terminal and maintaining stand-by state; capturing fingerprint data by scanning fingerprint through the fingerprint sensor, verifying image quality of the fingerprint data and transforming the fingerprint data into a template form; checking whether the captured fingerprint data is registered by comparing the captured fingerprint data with fingerprint data stored in all fingerprint data registration entry; in a case where the captured fingerprint data is not registered, generating a fingerprint data registration entry for the captured fingerprint data and storing the captured fingerprint data in a first slot of the fingerprint data registration entry having a plurality of slots; capturing fingerprint data by scanning fingerprint through the fingerprint sensor, verifying image quality of the fingerprint data and transforming the fingerprint data into a template form; comparing the captured fingerprint data with the fingerprint data stored in the first slot; and in a case where the captured fingerprint data is similar to the fingerprint data stored in the first slot, storing the captured fingerprint data in a second slot of the fingerprint data registration entry.

Preferably, the act of registering a plurality of fingerprint data may further comprise: capturing fingerprint data by scanning fingerprint through the fingerprint sensor, verifying image quality of the fingerprint data, transforming the fingerprint data into a template form, comparing the captured fingerprint data with the fingerprint data stored in the first slot and the second slot, and storing the captured fingerprint data in a slot next to the second slot of the fingerprint data registration entry, and wherein the acts of capturing, verifying, transforming, comparing and storing are able to be repeated for a plurality of times.

Preferably, the act of performing fingerprint authentication may comprise: in a case where a request of fingerprint authentication is received through a keypad of the mobile communication terminal, initializing the fingerprint sensor and maintaining stand-by state; in a case where type of matching for fingerprint authentication is 1 to 1, capturing fingerprint data by scanning fingerprint through the fingerprint sensor, verifying image quality of the fingerprint data, transforming the fingerprint data into a template form; and comparing the captured fingerprint data with the fingerprint data stored in a fingerprint data registration entry that user of the mobile communication terminal selects.

Preferably, the act of performing fingerprint authentication may further comprise: in a case where type of matching for fingerprint authentication is 1 to N, capturing fingerprint data by scanning fingerprint through the fingerprint sensor, verifying image quality of the fingerprint data, transforming the fingerprint data into a template form; and comparing the captured fingerprint data with fingerprint data stored in all fingerprint data registration entries.

Preferably, the act of performing fingerprint authentication may further comprise: in a case where there is a fingerprint data similar to the captured fingerprint data in the fingerprint data registration entry, searching fingerprint data having a least similarity among fingerprint data in the fingerprint data registration entry; and deleting the fingerprint data having the least similarity from the fingerprint data registration entry and updating the fingerprint data registration entry by replacing the deleted fingerprint data with the captured fingerprint data.

Preferably, the act of performing fingerprint authentication may further comprise: in a case where there is a fingerprint data similar to the captured fingerprint data in the fingerprint data registration entries, searching fingerprint data having a least similarity among fingerprint data in a fingerprint data registration entry storing the fingerprint data similar to the captured fingerprint data; and deleting the fingerprint data having the least similarity from the fingerprint data registration entry and updating the fingerprint data registration entry by replacing the deleted fingerprint data with the captured fingerprint data.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an apparatus for fingerprint authentication in a mobile communication terminal according to an embodiment of the present invention;

FIG. 2 is a flow chart illustrating a method for fingerprint authentication in a mobile communication terminal according to an embodiment of the present invention;

FIG. 3 illustrates an example of a structure of registered fingerprint data;

FIG. 4 is a state diagram for illustrating a process of registering fingerprint data illustrated in FIG. 2; and

FIG. 5 is a state diagram for illustrating a process for fingerprint authentication in FIG. 2.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

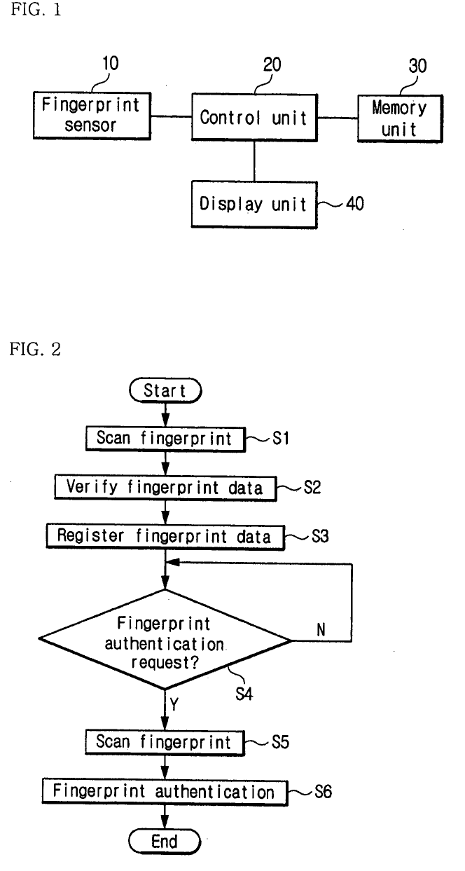

FIG. 1 illustrates an apparatus for fingerprint authentication in a mobile communication terminal according to an embodiment of the present invention. As illustrated in FIG. 1, the apparatus for fingerprint authentication in a mobile communication terminal comprises a fingerprint sensor 10, a control unit 20, a memory unit 30 and a display unit 40.

The fingerprint sensor 10 scans a fingerprint of a user and transmits the fingerprint data captured by the scan to the control unit 20.

The control unit 20 checks whether condition of the captured fingerprint data is adequate for fingerprint authentication, verifies whether the captured fingerprint data is fingerprint data of a same finger, and registers the verified fingerprint data in the memory unit 30. In addition, the control unit 20 performs fingerprint authentication by checking whether the captured fingerprint data is similar to fingerprint data previously registered in the memory unit 30. Further, the control unit 20 updates fingerprint data registration entry having the previously registered fingerprint data after the fingerprint authentication by replacing the previously registered fingerprint data with the captured fingerprint data.

The memory unit 30 stores the registered fingerprint data according to controls of the control unit 20. The memory unit 30 configures fingerprint data registration entries having a plurality of slots (for example, three slots per one entry) corresponding to each fingerprint data and stores the fingerprint data in a template form (“fingerprint template”) in each slot.

The display unit 40 displays a message requesting a user to input a fingerprint data according to controls of the control unit 20.

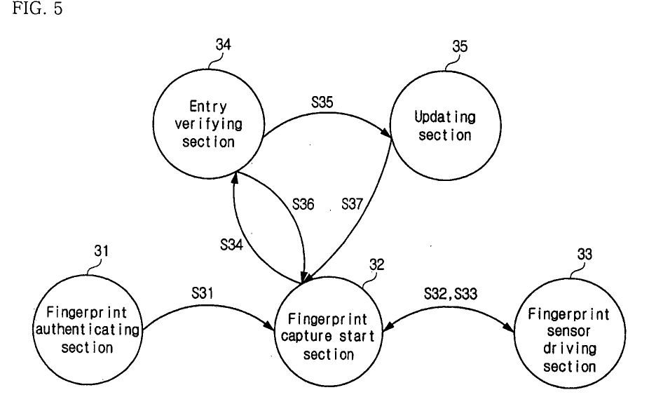

FIG. 4 illustrates configuration of the control unit 20 for registering a fingerprint data according to an embodiment of the present invention. As illustrated, the control unit comprises a fingerprint registering section 21, a fingerprint capture start section 22, a fingerprint sensor driving section 23, an entry verifying section 24, a template storing section 25, and a plurality of template verifying sections 26, 27.

The fingerprint registering section 21 recognizes a request of fingerprint registration when a user requests a fingerprint registration through a keypad of a mobile communication terminal, applies the request of the fingerprint registration to the fingerprint capture start section 22, and completes the fingerprint registration by receiving notification of fingerprint registration success from the template verifying section.

The fingerprint capture start section 22 applies an initialization command for initializing the fingerprint sensor 10 to the fingerprint sensor driving section 23 after receiving the request of fingerprint registration from the fingerprint registering section 21, after receiving notification of fingerprint data verification failure from the entry verifying section 24, or after receiving notification of template verification failure from the template verifying section 26, 27. Further, the fingerprint capture start section 22 receives notification of fingerprint data capture completion from the fingerprint sensor driving section 23, asks the entry verifying section 24 to perform fingerprint data verification for verifying whether the captured fingerprint data is similar to fingerprint data previously registered in entries of the memory unit 30, and asks the template verifying section 26, 27 to check whether newly captured fingerprint data is similar to fingerprint data captured prior to the newly captured fingerprint data and to store the fingerprint template therein.

The fingerprint sensor driving section 23 initializes the fingerprint sensor 10 by receiving the initialization command from the fingerprint capture start section 22 or receiving a request of recapturing fingerprint data, maintains stand-by state until fingerprint data is captured, checks whether condition of the captured fingerprint data is adequate for fingerprint authentication, and notifies the fingerprint capture start section 22 of fingerprint data capture completion.

The entry verifying section 24 receives the request of fingerprint data verification from the fingerprint capture start section 22 and, then, compares the fingerprint data captured through the fingerprint sensor 10 with fingerprint data previously registered in entries of the memory unit 30 for checking whether the fingerprint data captured through the fingerprint sensor 10 is similar to the other fingerprint data previously registered in the entries of the memory unit 30.

When there exists a similar fingerprint data during a process of fingerprint data registration, the entry verifying section 24 notifies the fingerprint capture start section 22 of the fact, and when there is no similar fingerprint data during the process of fingerprint data registration, the entry verifying section 24 asks the template storing section 25 to store the fingerprint data in a template form therein.

The template storing section 25 receives a request of storing the fingerprint template from the entry verifying section 24, generates a fingerprint data registration entry in the memory unit 30 corresponding to the fingerprint template, stores the template-transformed fingerprint dada in a first slot of the corresponding fingerprint data registration entry, and asks the fingerprint sensor driving section 23 to prepare recapturing of fingerprint data.

The template verifying section 26, 27 receives request of checking whether the captured fingerprint data is similar to the previous fingerprint data and request of storing the fingerprint template from the fingerprint capture start section 22, and compares the captured fingerprint data with the fingerprint data previously stored in the slot of the corresponding fingerprint data registration entry of the memory unit 30 for checking whether the captured fingerprint data is similar to the fingerprint data stored in the slot. When there is no fingerprint data similar to the captured fingerprint data in the slot, the template verifying section notifies the fingerprint capture start section 22 of template verification failure. On the other hand, when there is fingerprint data similar to the captured fingerprint data in the slot, it stores the captured fingerprint data in a slot next to the previous slot of the corresponding fingerprint data registration entry in a template form, and then asks the fingerprint sensor driving section 23 to prepare recapturing of fingerprint data or notifies the fingerprint registering section 21 of fingerprint registration success.

Preferably, the template verifying section may comprise, for example, a second template verifying section 26 and a third template verifying section 27.

The second template verifying section 26 receives a request of checking whether the captured fingerprint data is similar to the previous fingerprint data and a request of storing the fingerprint data in a template form from the fingerprint capture start section 22, and compares fingerprint data secondly successively captured through the fingerprint sensor 10 with the fingerprint data previously stored in the first slot of the corresponding fingerprint data registration entry in the memory unit 30 for checking whether the fingerprint data secondly successively captured through the fingerprint sensor 10 is similar to the fingerprint data stored in the first slot.

When there is no fingerprint data, similar to the fingerprint data secondly successively captured through the fingerprint sensor 10, in the first slot, the second template verifying section notifies the fingerprint capture start section 22 of template verification failure. On the other hand, when there is fingerprint data similar to the fingerprint data secondly successively captured through the fingerprint sensor 10 in the first slot, it stores the fingerprint data secondly successively captured through the fingerprint sensor 10 in a second slot next to the first slot of the corresponding fingerprint data registration entry in a template form, and then asks the fingerprint sensor driving section 23 to prepare recapturing of fingerprint data.

The third template verifying section 27 receives requests of checking whether fingerprint data thirdly successively captured through the fingerprint sensor 10 is similar to the previous fingerprint data and request of storing the fingerprint data in a template form, from the fingerprint capture start section 22, and compares the fingerprint data thirdly successively captured through the fingerprint sensor 10 with the fingerprint data previously stored in all slots of the corresponding fingerprint data registration entry in the memory unit 30 for checking whether the fingerprint data thirdly successively captured through the fingerprint sensor 10 is similar to the fingerprint data stored in all the slots of the corresponding fingerprint data registration entry.

When there is no fingerprint data, similar to the fingerprint data thirdly successively captured through the fingerprint sensor 10, in the all slots, the third template verifying section 27 notifies the fingerprint capture start section 22 of template verification failure. On the other hand, when there is fingerprint data, similar to the fingerprint data thirdly successively captured through the fingerprint sensor 10, in the slots, it stores the fingerprint data thirdly successively captured through the fingerprint sensor 10 in a third slot next to the second slot of the corresponding fingerprint data registration entry in a template form, and then notifies the fingerprint registering section 21 of fingerprint registration success.

FIG. 5 illustrates configuration of the control unit 20 for fingerprint authentication in an apparatus for fingerprint authentication in a mobile communication terminal according to an embodiment of the present invention. As illustrated in FIG. 5, the control unit 20 comprises a fingerprint authenticating section 31, a fingerprint capture start section 32, a fingerprint sensor driving section 33, an entry verifying section 34 and an updating section 35.

The fingerprint authenticating section 31 recognizes request of fingerprint authentication when fingerprint authentication is requested through keypads of a mobile communication terminal, applies the request of fingerprint authentication and information on type of matching (e.g. 1 to 1 matching or 1 to N matching) to the fingerprint capture start section 32, and completes fingerprint registration by receiving notification of fingerprint registration success from the fingerprint capture start section 32.

The fingerprint capture start section 32 applies an initialization command for initializing the fingerprint sensor 10 to the fingerprint sensor driving section 33 after receiving request of fingerprint authentication from the fingerprint authenticating section 31 or after receiving notification of a verification failure from the entry verifying section 34. Further, the fingerprint capture start section 32 receives notification of fingerprint data capture completion from the fingerprint sensor driving section 33 and asks the entry verifying section 34 to perform fingerprint data verification for verifying whether the captured fingerprint data is similar to fingerprint data previously registered in entries in the memory unit 30.

The fingerprint sensor driving section 33 initializes the fingerprint sensor 10 by receiving the initialization command from the fingerprint capture start section 32, maintains stand-by state until fingerprint data is captured, checks whether condition of the fingerprint data is adequate for fingerprint authentication, and notifies the fingerprint capture start section 32 of fingerprint data capture completion.

The entry verifying section 34 receives the request of fingerprint data verification from the fingerprint capture start section 32 and, then, compares the captured fingerprint data with other fingerprint data previously registered in entries of the memory unit 30. At this time, whether type of the matching is 1 to 1 or 1 to N is checked first. When the type of the matching is 1 to 1, fingerprint data stored in slots of a certain entry selected by the user and captured fingerprint data are compared. On the other hand, the type of the matching is 1 to N, the captured fingerprint data is compared with all fingerprint data stored in slots of every entry in the memory unit 30. In a case where there is no similarity, the fingerprint capture start section 32 is notified that the fingerprint authentication is failed. On the other hand, in a case where there is a similarity between the fingerprint data stored in the slots and the captured fingerprint data, the updating section 35 is notified that the fingerprint authentication is succeeded.

The updating section 35 receives notification of fingerprint authentication success from the entry verifying section 34, forwards information on No. of entry storing fingerprint data that has similarity with the captured fingerprint data and the notification of fingerprint authentication success to the fingerprint capture start section 32, and updates the entry storing the fingerprint data that has similarity in the memory unit 30.

More particularly, the updating section 35 searches fingerprint template having the least similarity among the three fingerprint template stored in the fingerprint data registration entry, deletes the fingerprint data having the least similarity from a corresponding slot of the entry and performs an update operation by replacing the deleted fingerprint data with the captured fingerprint data.

Hereinafter, a method for fingerprint authentication in a mobile communication terminal according to an embodiment of the present invention will de described with reference to a flow chart illustrated in FIG. 2.

First, a process for fingerprint data registration will be described. For fingerprint data registration, fingerprint of genuine user is scanned through the fingerprint sensor 10 repeatedly (e.g. at least three times) and fingerprint data captured by the act of scanning is stored. The reason why the fingerprint scan is performed repeatedly is that fingerprint scan through many times improves a probability of an authentication success and an registration success and prevents a mis-authentication.

The fingerprint sensor 10 scans the fingerprint and transmits the fingerprint data captured by scanning the fingerprint through the fingerprint sensor 10 to the control unit 20. The control unit 20 checks whether image quality of the fingerprint data is adequate (S1), and then verifies whether the fingerprint data is a fingerprint data of the same finger (S2).

As a result of the verification, when the fingerprint data is a fingerprint data of the same finger, the control unit 20 stores and registers the verified fingerprint data in the memory unit 30 (S3).

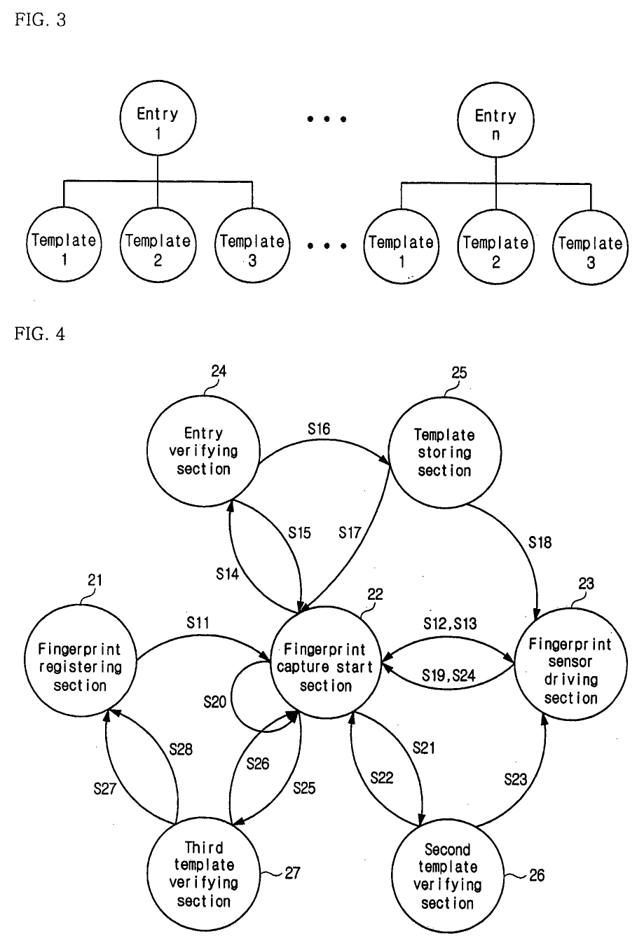

FIG. 3 illustrates configuration of fingerprint data registration in the memory unit 30. One fingerprint data registration entry comprises a plurality of slots (e.g. three slots) and each slot has a fingerprint data.

In other words, all of the fingerprint data captured by scanning the fingerprint through the fingerprint sensor 10 are stored in a template form in the memory unit 30. The template is binary data that stores only characteristic points of the fingerprint data through a specific algorithm. All the fingerprint data captured by the scan through the fingerprint sensor 10 are transformed into template forms and then stored in the memory unit 30. In addition, in order to improve a probability of the authentication and to prevent a mis-authentication, a plurality of fingerprint template (e.g. at least three) is stored for one fingerprint. Then, a process of fingerprint authentication will be described.

When fingerprint authentication is requested through keypads of a mobile communication terminal after the process of fingerprint registration, the request of fingerprint authentication is recognized (S4). Then, the fingerprint sensor 10 is initialized to scan a fingerprint pursuant to the request and the fingerprint is scanned through the fingerprint sensor 10 (S5). The fingerprint sensor 10 transmits to the control unit 20 fingerprint data captured by scanning the fingerprint. The control unit checks whether condition of the captured fingerprint data is adequate. Then, in a case where condition of the captured fingerprint data is adequate, fingerprint authentication is performed to check whether there is similarity between the captured fingerprint data and the registered fingerprint data in the memory unit 30 by comparing the captured fingerprint data and the registered fingerprint data (S6).

For checking whether there is similarity between the captured fingerprint data and the registered fingerprint data in the memory unit 30, there are two cases. According to a first case, the captured fingerprint data is compared with registered fingerprint data stored in slots of a certain fingerprint data registration entry. The certain fingerprint data registration entry is determined by choice of the user. According to a second case, the captured fingerprint data is compared with registered fingerprint data stored in slots of all fingerprint data registration entries. At this time, the captured fingerprint data is compared with all the registered fingerprint data in the memory unit 30. The first case is termed as 1 to 1 matching and the second case is termed as 1 to N matching, wholly in this specification.

The fingerprint registration process (S1-S3) as described above will be more specifically explained with reference to FIG. 4.

The fingerprint registering section 21 recognizes a request of fingerprint registration through keypads of a mobile communication terminal, and transmits the request to the fingerprint capture start section 22 (S11). At this time, the fingerprint registration may be requested repeatedly (e.g. at least three times).

The fingerprint capture start section 22 transmits an initialization command for initializing the fingerprint sensor 10 to the fingerprint sensor driving section 23 (S12). The fingerprint sensor driving section 23 initializes the fingerprint sensor 10 pursuant to the initialization command and maintains a stand-by state until a fingerprint is scanned.

At this time, the control unit 20 controls the display unit 40 and a voice outputting part, etc. to output a message indicating that an initialization of the fingerprint sensor 10 is completed and a fingerprint scan is required.

When fingerprint is scanned in response to the message, the fingerprint data is captured through the fingerprint sensor 10. Then, the control unit 20 checks whether condition of the captured fingerprint data is adequate, and notifies the fingerprint capture start section 22 of fingerprint data capture completion in a case where it is checked by the control unit that the condition of the captured fingerprint data is adequate (S13).

At this time, image quality of the fingerprint data is verified by the control unit 20, in order to check whether the condition of the captured fingerprint data is adequate for fingerprint authentication.

In a case where the image quality of the fingerprint data is good, the control unit 20 transforms the fingerprint data to a template form and stores the fingerprint template temporarily. The notification of the fingerprint data capture completion may be performed after the verification of the image quality of the captured fingerprint data or after the transformation.

In contrast, in a case where the image quality of the fingerprint data is not good, the fingerprint capture start section 22 is notified that the image quality of the fingerprint data is not good, and the control unit 20 controls the display unit 40 and a voice outputting part, etc. to output a message indicating that a new fingerprint scan is required. Then, when a new fingerprint is scanned through the fingerprint sensor 10, the above processes such as the process of verifying image quality thereof and the process of transforming are performed.

After the notification of the fingerprint data capture completion, the fingerprint capture start section 22 asks the entry verifying section 24 to perform fingerprint data verification for verifying whether there is a registered fingerprint data similar to the captured fingerprint data (S14).

Pursuant to the request of fingerprint data verification, the entry verifying section 24 compares the captured fingerprint data with the registered fingerprint data. Objects of comparison in this specification such as the captured fingerprint data and the fingerprint data registered in the memory unit are all fingerprint templates.

In a case where there is the registered fingerprint data similar to the captured fingerprint data, the fingerprint capture start section 22 is notified that there is the registered fingerprint data similar to the captured fingerprint data (S15). Then, in order to store a preset number (e.g. at least three) of fingerprint template, the control unit 20 controls the display unit 40 and the voice outputting part, etc. to output a message indicating that a new fingerprint scan is required.

In contrast, in a case where there is no registered fingerprint data similar to the captured fingerprint data, the entry verifying section 24 asks the template storing section 25 to store the fingerprint template in a new entry (S16). The template storing section 25 stores the fingerprint template in a first slot of the new entry. At this time, in a case where the fingerprint template is not successfully stored in a first slot of the new entry, the fingerprint capture start section 22 is notified that the fingerprint template is not successfully stored (S17). Then, the control unit 20 controls the display unit 40 and the voice outputting part, etc. to output a message indicating that a fingerprint scan is required.

Then, the template storing section 25 asks the fingerprint sensor driving section 23 to prepare recapturing of fingerprint data (S18).

When fingerprint is scanned in response to the message, the fingerprint data is captured through the fingerprint sensor 10. Then, the control unit 20 checks whether condition of the captured fingerprint data is adequate and notifies the fingerprint capture start section 22 of fingerprint data capture completion in a case where it is checked by the fingerprint sensor driving section 23 that the condition of the captured fingerprint data is adequate (S19). In a case where the fingerprint capture start section 22 does not receive notification of fingerprint data capture completion from the fingerprint sensor driving section 23 for a certain time, the fingerprint capture start section 22 considers that the fingerprint scan is failed (S20). Then, the control unit 20 controls the display unit 40 and the voice outputting part, etc. to output a message indicating that a fingerprint scan is required. When fingerprint is scanned in response to the message, the fingerprint data is captured through the fingerprint sensor 10. To check whether the condition of the captured fingerprint data is adequate, image quality of the captured fingerprint data is verified by the control unit 20, as described above.

In a case where the image quality of the fingerprint data is good, the control unit 20 transforms the fingerprint data to a template form and stores the fingerprint template temporarily. The notification of the fingerprint data capture completion may be performed after the verification of the image quality of the fingerprint data or after the transformation.

In contrast, in a case where the image quality of the captured fingerprint data is not good, the fingerprint capture start section 22 is notified that the image quality of the captured fingerprint data is not good, and the control unit 20 controls the display unit 40 and a voice outputting part, etc. to output a message indicating that a new fingerprint scan is required. Then, when a new fingerprint is scanned through the fingerprint sensor 10, the above processes such as the process of verifying image quality thereof and the process of transforming are performed.

The fingerprint capture start section 22 asks the second template verifying section 26 to check whether there is similarity between the captured fingerprint data and the fingerprint data stored in the first slot and to store the captured fingerprint data in a case where there is similarity between the captured fingerprint data and the fingerprint data stored in the first slot (S21). The second template verifying section 26 compares the captured fingerprint data and the fingerprint data stored in the first slot to check whether there is similarity between the captured fingerprint data and the fingerprint data stored in the first slot.

In a case where there is similarity between the captured fingerprint data and the fingerprint data stored in the first slot, the second template verifying section 26 stores the captured fingerprint data in a template form in a second slot and the template storing section 25 asks the fingerprint sensor driving section 23 to prepare to capture another fingerprint data (S23).

On the other hand, in a case where there is no similarity between the captured fingerprint data and the fingerprint data stored in the first slot, the fingerprint capture start section 22 is notified that there is no similarity between the captured fingerprint data and the fingerprint data stored in the first slot (S22). Then, the control unit 20 controls the display unit 40 and the voice outputting part, etc. to output a message indicating that a fingerprint scan is required.

After storing the captured fingerprint data in a second slot, the control unit 20 controls the display unit 40 and the voice outputting part, etc. to output a message indicating that a fingerprint scan is required. When fingerprint is scanned in response to the message, the fingerprint data is captured through the fingerprint sensor 10. As with the fingerprint template in the first slot and the second slot, image quality of the captured fingerprint data is verified by the control unit 20 to check whether the condition of the captured fingerprint data is adequate for fingerprint authentication, the fingerprint data is transformed into a template form in a case where the image quality of the captured fingerprint data is good, and the fingerprint template is stored temporarily. Then, the fingerprint sensor driving section 23 notifies the fingerprint capture start section 22 of fingerprint data capture completion (S24).

The fingerprint capture start section 22 asks the third template verifying section 26 to check whether there is similarity between the captured fingerprint data and the fingerprint data stored in the first slot and the second slot and to store the captured fingerprint data (S25). The third template verifying section 26 compares the captured fingerprint data and the fingerprint data stored in the first slot and the second slot to check whether there is similarity between the captured fingerprint data, and the fingerprint data stored in the first slot and the second slot.

In a case where there is no similarity between the captured fingerprint data, and the fingerprint data stored in the first slot and the second slot, the fingerprint capture start section 22 is notified that there is no similarity between the captured fingerprint data, and the fingerprint data stored in the first slot and the second slot (S26). Then, the control unit 20 controls the display unit 40 and the voice outputting part, etc. to output a message indicating that a fingerprint scan is required.

In contrast, in a case where there is similarity between the captured fingerprint data, and the fingerprint data stored in the first slot and the second slot, the captured fingerprint data is stored in a third slot in the memory unit 30. Then, fingerprint registration is completed, by notifying the fingerprint registering section 21 of fingerprint registration success (S27).

In a case where fingerprint registration is failed, the fingerprint registering section 21 is notified that fingerprint registration is failed (S28). Then, the control unit 20 controls the display unit 40 and the voice outputting part, etc. to output a message indicating that a fingerprint scan is required.

Hereinafter, the process for fingerprint authentication (S4-S6) will be explained with reference to FIG. 5.

The fingerprint authenticating section 31 recognizes request of the fingerprint authentication when receiving the request of the fingerprint authentication through keypads of a mobile communication terminal, and transmits the request of the fingerprint authentication to the fingerprint capture start section 32 (S31).

At this time, the fingerprint authenticating section 31 also informs the fingerprint capture start section 32 of information about a 1 to 1 matching when entry for fingerprint authentication is known or a 1 to N matching when entry for fingerprint authentication is not known. In a case of the 1 to 1 matching, the fingerprint authenticating section 31 informs the fingerprint capture start section 32 of the information about the entry for fingerprint authentication as well.

After the fingerprint capture start section 32 receives the request of the fingerprint authentication from the fingerprint authenticating section 31 and checks whether the request is a 1 to 1 matching request or a 1 to N matching request, it transmits an initialization command for initializing the fingerprint sensor 10 to the fingerprint sensor driving section 33 (S32). The fingerprint sensor driving section 33 initializes the fingerprint sensor 10 according to the initialization command and maintains a standby state until a fingerprint is scanned.

At this time, the control unit 20 controls the display unit 40 and a voice outputting part, etc. to output a message indicating that a fingerprint scan is required. In a case of the 1 to 1 matching, a message asking both selection of the entry for fingerprint authentication and input of fingerprint is outputted.

When fingerprint is scanned through the fingerprint sensor 10 in response to the message, fingerprint data is captured by the fingerprint scan. The control unit 20 checks whether condition of the captured fingerprint data is adequate. In case of a 1 to 1 matching, the control unit 20 checks information on entry selected by the user as well.

For checking whether condition of the captured fingerprint data is adequate, the control unit 20 verifies image quality of the captured fingerprint data. In a case where image quality of the captured fingerprint data is not good, the fingerprint capture start section 32 is notified that the image quality of the fingerprint data is not good. The control unit 20 controls the display unit 40 and a voice outputting part, etc. to output a message indicating that a fingerprint scan is required.

In a case where the image quality of the fingerprint data is good, the control unit 20 transforms the fingerprint data into a template form and stores the fingerprint template temporarily.

The fingerprint capture start section 32 asks the entry verifying section 34 to verify the captured fingerprint data by comparing the captured fingerprint data with fingerprint data previously registered in the memory unit 30 and the entry verifying section 34 checks whether there is a similar fingerprint data by comparing the captured fingerprint data with the fingerprint data previously registered in the memory unit 30 (S34).

At this time, in a case of the 1 to 1 matching, the entry verifying section reads from the memory unit 30 the fingerprint data of the slots corresponding to an entry selected by the user and then compares the read fingerprint data stored in the slots with the captured fingerprint data. In a case where there is a similar fingerprint data, the entry verifying section 34 notifies the updating section 35 of the success of fingerprint authentication (S35).

Alternatively, in a case of the 1 to 1 matching, the entry verifying section 34 sequentially reads all fingerprint data registered in the memory unit 30, and compares the captured fingerprint data with all the fingerprint data registered in the memory unit 30. In a case where there is a similar fingerprint data, the entry verifying section 34 notifies the updating section 35 of the success of fingerprint authentication.

In contrast, in a case where there is no similar fingerprint data, the entry verifying section 34 notifies the fingerprint capture start section 32 of the failure of fingerprint authentication (S36). The control unit 20 controls the display unit 40 and a voice outputting part, etc. to output a message indicating that fingerprint authentication is failed and a fingerprint scan is required.

The updating section 35 forwards to the fingerprint capture start section 32 information on whether fingerprint authentication is succeeded and No. of the entry where the similar fingerprint data is stored (S37) and updates fingerprint data registration entries in the memory unit 30.

Hereinafter, the operations of the updating section 35 will be explained more particularly.

In a case where the entry verifying section 34 finds the matched fingerprint data registration entry from the memory unit 30, the updating section 35 searches fingerprint template having the least similarity among the three fingerprint template stored in the fingerprint data registration entry, deletes the fingerprint template having the least similarity from a corresponding slot of the entry and performs an update operation by replacing the deleted fingerprint template with the fingerprint template that succeeded in fingerprint authentication.

As described above, according to the present invention, the registered fingerprint template is not permanently used in a mobile communication terminal equipped with a fingerprint sensor. Instead, the fingerprint data is properly updated according to environments or fingerprint condition of a user. Accordingly, it is possible to cope with a change of a condition of the fingerprint sensor or a surrounding situation and to improve the probabilities of the fingerprint registration and authentication.

While the invention has been shown and described with reference to certain preferred embodiments thereof, it will be understood by those skilled in the art that various changes in form and details may be made therein without departing from the spirit and scope of the invention as defined by the appended claims. In addition, it should be understood that although the embodiment described above is explained with regard to the fingerprint authentication in a mobile communication terminal, it can be applied to all apparatuses or devices using a fingerprint authentication function.

1. An apparatus for fingerprint authentication in a mobile communication terminal comprising:
a memory unit for configuring fingerprint data registration entries corresponding to fingerprints, the fingerprint data registration entry including a plurality of slots, and storing fingerprint data in each of the slots, the fingerprint data being captured by a fingerprint sensor provided in the mobile communication terminal; and
a control unit for checking whether condition of the captured fingerprint data is adequate for fingerprint authentication, verifying whether the captured fingerprint data is fingerprint data of a same finger, and performing fingerprint authentication by checking whether there is a similarity between the captured fingerprint data and fingerprint data previously stored in each of the slots.

2. The apparatus of claim 1, wherein the control unit comprises:
a fingerprint registering section for recognizing a request of fingerprint registration inputted through a keypad of the mobile communication terminal;
a fingerprint capture start section for generating an initialization command for initializing the fingerprint sensor after receiving the request of fingerprint registration from the fingerprint registering section, for receiving notification of fingerprint data capture completion, for requesting fingerprint data verification, and for asking a template verifying section to check whether the captured fingerprint data is similar to the fingerprint data previously stored in each of the slots;
a fingerprint sensor driving section for initializing the fingerprint sensor after receiving the initialization command from the fingerprint capture start section, maintaining stand-by state until new fingerprint data is captured, and notifying the fingerprint capture start section of fingerprint data capture completion in a case where the captured fingerprint data is adequate for fingerprint authentication;
an entry verifying section for receiving the request of fingerprint data verification from the fingerprint capture start section, comparing the captured fingerprint data with the fingerprint data previously stored in each of the slots, and requesting storage of the captured fingerprint data during a fingerprint data registration process in a case where there is no similarity between the captured fingerprint data and the fingerprint data previously stored in each of the slots;
a template storing section for receiving the request of storing the captured fingerprint data from the entry verifying section, generating a fingerprint data registration entry corresponding to the captured fingerprint data, storing the captured fingerprint data in a template form in a first slot of the fingerprint data registration entry, and asking the fingerprint sensor driving section to prepare recapturing of fingerprint data; and
the template verifying section for receiving a request of checking whether the captured fingerprint data is similar to fingerprint data stored prior to the captured fingerprint data, comparing the captured fingerprint data with the fingerprint data stored prior to the captured fingerprint data, and storing the captured fingerprint data in a template form in a slot next to a slot of the fingerprint data stored prior to the captured fingerprint data.

3. The apparatus of claim 2, wherein the entry verifying section compares the captured fingerprint data with the fingerprint data previously stored in the slots, and makes the fingerprint capture start section generate the initialization command by notifying the fingerprint capture start section that there is a similarity between the captured fingerprint data and the fingerprint data previously stored in the slots in a case where there is fingerprint data similar to the captured fingerprint data.

4. The apparatus of claim 2, wherein the template verifying section comprises:
a second template verifying section for comparing the captured fingerprint data with the fingerprint data stored prior to the captured fingerprint data after receiving the request of checking whether the captured fingerprint data is similar to the fingerprint data stored prior to the captured fingerprint data, storing the captured fingerprint data in a template form in a second slot of the corresponding entry in a case where there is a similarity between the captured fingerprint data and the fingerprint data stored prior to the captured fingerprint data, and requesting recapturing of fingerprint data; and
a third template verifying section for comparing fingerprint data captured through the fingerprint sensor with fingerprint data stored in a first slot and a second slot after receiving the request of checking whether the captured fingerprint data is similar to the fingerprint data stored prior to the captured fingerprint data, storing the captured fingerprint data in a template form in a third slot of the corresponding entry in a case where there is similarity between the captured fingerprint data and the fingerprint data stored prior to the captured fingerprint data, and notifying the fingerprint registering section of fingerprint data registration success.

5. The apparatus of claim 2, wherein the template verifying section compares the captured fingerprint data with the fingerprint data stored prior to the captured fingerprint data, and makes the fingerprint capture start section generate the initialization command by notifying the fingerprint capture start section that there is no similarity between the captured fingerprint data and the fingerprint data stored prior to the captured fingerprint data in a case where there is no fingerprint data similar to the captured fingerprint data.

6. The apparatus of claim 4, wherein the template verifying section compares the captured fingerprint data with the fingerprint data stored prior to the captured fingerprint data, and makes the fingerprint capture start section generate the initialization command by notifying the fingerprint capture start section that there is no similarity between the captured fingerprint data and the fingerprint data stored prior to the captured fingerprint data in a case where there is no fingerprint data similar to the captured fingerprint data.

7. The apparatus of claim 1, wherein the control unit comprises:
a fingerprint authenticating section for recognizing a request of fingerprint authentication inputted through a keypad of the mobile communication terminal, and applying the request of fingerprint authentication and information on type of matching to a fingerprint capture start section;
the fingerprint capture start section for generating an initialization command for initializing the fingerprint sensor after receiving the request of fingerprint authentication from the fingerprint authenticating section, for receiving fingerprint data capture completion, for requesting fingerprint data verification and for asking an entry verifying section to check whether the captured fingerprint data is similar to the previously stored fingerprint data;
a fingerprint sensor driving section for initializing the fingerprint sensor after receiving the initialization command from the fingerprint capture start section, maintaining stand-by state until new fingerprint data is captured, and notifying the fingerprint capture start section of fingerprint data capture completion in a case where the captured fingerprint data is adequate for fingerprint authentication; and
the entry verifying section for receiving the request of fingerprint data verification from the fingerprint capture start section and performing fingerprint authentication by comparing the captured fingerprint data with the fingerprint data previously stored in each of the slots.

8. The apparatus of claim 7, wherein the entry verifying section compares the captured fingerprint data with fingerprint data stored in a certain fingerprint data registration entry selected by a user in a case where the type of matching is 1 to 1, and compares the captured fingerprint data with fingerprint data stored in all slots in a case where the type of matching is 1 to N.

9. The apparatus of claim 7, further comprising:
an updating section for forwarding to the fingerprint capture start section the notification of fingerprint authentication success and No. of fingerprint data registration entry storing fingerprint data similar to the captured fingerprint data, after receiving the notification of fingerprint authentication success from the entry verifying section, and updating the fingerprint data registration entry.

10. The apparatus of claim 9, wherein the updating section searches fingerprint data having a least similarity among the fingerprint data in the fingerprint data registration entry, deletes the fingerprint data having the least similarity from a corresponding slot of the fingerprint data registration entry, and updates the fingerprint data registration entry by replacing the deleted fingerprint data with the captured fingerprint data.

11. A method for fingerprint authentication in a mobile communication terminal comprising:
registering a plurality of fingerprint data by capturing the fingerprint data through using fingerprint sensor provided in the mobile communication terminal, checking whether the fingerprint data is fingerprint data of a same fingerprint, and storing the fingerprint data in slots consisting of one fingerprint data registration entry in a case where the fingerprint data is fingerprint data of a same finger; and
performing fingerprint authentication by checking whether a fingerprint data captured for fingerprint authentication is adequate for fingerprint authentication and checking whether there is a similarity between the captured fingerprint data and the fingerprint data stored in slots.

12. The method of claim 11, wherein the act of registering a plurality of fingerprint data comprises:
initializing the fingerprint sensor when receiving a request of fingerprint registration inputted from a keypad of the mobile communication terminal and maintaining stand-by state;
capturing fingerprint data by scanning fingerprint through the fingerprint sensor, verifying image quality of the fingerprint data and transforming the fingerprint data into a template form;
checking whether the captured fingerprint data is registered by comparing the captured fingerprint data with fingerprint data stored in all fingerprint data registration entry;
in a case where the captured fingerprint data is not registered, generating a fingerprint data registration entry for the captured fingerprint data and storing the captured fingerprint data in a first slot of the fingerprint data registration entry having a plurality of slots;
capturing fingerprint data by scanning fingerprint through the fingerprint sensor, verifying image quality of the fingerprint data and transforming the fingerprint data into a template form;
comparing the captured fingerprint data with the fingerprint data stored in the first slot; and
in a case where the captured fingerprint data is similar to the fingerprint data stored in the first slot, storing the captured fingerprint data in a second slot of the fingerprint data registration entry.

13. The method of claim 12, wherein the act of registering a plurality of fingerprint data further comprises:
capturing fingerprint data by scanning fingerprint through the fingerprint sensor, verifying image quality of the fingerprint data, transforming the fingerprint data into a template form, comparing the captured fingerprint data with the fingerprint data stored in the first slot and the second slot, and storing the captured fingerprint data in a slot next to the second slot of the fingerprint data registration entry, and wherein the acts of capturing, verifying, transforming, comparing and storing are able to be repeated for a plurality of times.

14. The method of claim 11, wherein the act of performing fingerprint authentication comprises:
in a case where a request of fingerprint authentication is received through a keypad of the mobile communication terminal, initializing the fingerprint sensor and maintaining stand-by state;
in a case where type of matching for fingerprint authentication is 1 to 1, capturing fingerprint data by scanning fingerprint through the fingerprint sensor, verifying image quality of the fingerprint data, transforming the fingerprint data into a template form; and
comparing the captured fingerprint data with the fingerprint data stored in a fingerprint data registration entry that user of the mobile communication terminal selects.

15. The method of claim 14, wherein the act of performing fingerprint authentication further comprises:
in a case where type of matching for fingerprint authentication is i to N, capturing fingerprint data by scanning fingerprint through the fingerprint sensor, verifying image quality of the fingerprint data, transforming the fingerprint data into a template form; and
comparing the captured fingerprint data with fingerprint data stored in all fingerprint data registration entries.

16. The method of claim 14, wherein the act of performing fingerprint authentication further comprises:
in a case where there is a fingerprint data similar to the captured fingerprint data in the fingerprint data registration entry, searching fingerprint data having a least similarity among fingerprint data in the fingerprint data registration entry; and
deleting the fingerprint data having the least similarity from the fingerprint data registration entry and updating the fingerprint data registration entry by replacing the deleted fingerprint data with the captured fingerprint data.

17. The method of claim 15, wherein the act of performing fingerprint authentication further comprises:
in a case where there is a fingerprint data similar to the captured fingerprint data in the fingerprint data registration entries, searching fingerprint data having a least similarity among fingerprint data in a fingerprint data registration entry storing the fingerprint data similar to the captured fingerprint data; and
deleting the fingerprint data having the least similarity from the fingerprint data registration entry and updating the fingerprint data registration entry by replacing the deleted fingerprint data with the captured fingerprint data.
